(19) United States
(12) Patent Application Publication
(10) Pub. No.: US 2007/0025786 A1
(43) Pub. Date: Feb. 1, 2007

(54) Image forming apparatus including a cleaning mechanism capable of effective cleaning without damage

(76) Inventors: Tomoki Yasuhara, Atsugi-shi (JP); Yusuke Odashima, Atsugi-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/493,811

(22) Filed: Jul. 27, 2006

(30) Foreign Application Priority Data
Jul. 29, 2005 (JP) 2005-220771

(51) Int. Cl. G03G 21/00

(52) U.S. Cl. 399/350

(57) ABSTRACT

An image forming apparatus which includes an image carrier configured to form a toner image, a transfer roller configured to transfer the toner image to a recording medium, a gap controlling member configured to keep a predetermined distance between the image carrier and the transfer roller and a cleaning member configured to clean a surface of the image carrier, arranged to touch a contacting area on the surface of the image carrier with the gap controlling member and formed of a porous fibrous material in at least a contacting area of the cleaning member contacting with the image carrier.

This patent specification is based on Japanese patent application, No. 2005-220771 filed on Jul. 29, 2005 in the Japan Patent Office, the entire contents of which are incorporated by reference herein.

### BACKGROUND OF THE INVENTION

1. Field of the Invention

The present invention relates to an image forming apparatus which includes a cleaning mechanism capable of effective cleaning with no damage occurring as a result.

2. Description of the Related Art

A background image forming apparatus using electrophotographic process generally includes a transfer roller serving as a transferring mechanism. The transfer roller is configured to be rotated and to contact with an image carrier so as to transfer a toner image formed on an image carrier to a recording medium while the recording medium is passing through the transfer roller.

The toner image is transferred under a bias voltage applied to the transfer roller and a pressure force of the transfer roller to the image carrier. The transfer roller is pushed onto a surface of the image carrier with a predetermined pressure using a pressing member. It is difficult to obtain a pressuring force uniformly in the entire contacting area of the transfer roller to the image carrier in a longitude direction of the image carrier due to errors of the pressing member during fabrication and assembly. Gap rollers are generally arranged at both ends of the transfer roller so that the transfer roller contacts with the image carrier uniformly in a longitudinal direction of the image carrier and pushes with a pressure force below a predetermined value.

Paper jams may occur at a point between the image carrier and the transfer roller while the recording medium is passing through the transfer roller. The transfer roller is normally arranged on an opening and closing door attached to a main body of the image forming apparatus so as to be removable from the image carrier and fix the paper jam.

The gap rollers arranged at both ends of the transfer roller are also removable. When the opening and closing door is closed, the transfer roller and the gap rollers are pushed to the image carrier. An error in the assembly of the opening and closing door to the main body of the image forming apparatus is relatively large in comparison to the error in assembly of the members which are integrated in a cartridge. The elastic force of the transfer roller and the gap rollers attached on the opening and closing door to the image carrier is stronger than other gap roller which integrated with the image carrier. Therefore, marking problems occurring on the surface of the image carrier by the gap roller is a notable event.

Thus, the image carrier is marked due to the large pushing force thereon. After for example a few thousand of processings, the surface of the image carrier is marked by the gap roller and is damaged. If an aluminum drum of an organic photoconductor is marked and particles of aluminum are generated by shaving, the shaving particles may fly into a development unit. Electrostatic discharge may occur at a charging unit and the image carrier got damaged. The image forming apparatus may have printing quality problems, for example black dots and string lines. To solve the problem, a variety of the cleaning mechanisms using a gap roller are proposed.

In one example of the cleaning mechanisms, a gap roller is disposed so as to be located outside of a developing effective width region of a developing device, or an electrifying effective width region of the electrifying member, or a cleaning effective width region of a cleaning mechanism, or a transfer effective width region of a transfer member corresponding to a surface region of the image carrier. The cleaning blade is extending to a position of the gap roller so that a making trouble caused by the shavings of the mark of the roller of the image carrier is prevented.

However, forming the cleaning blade longer is against standardization of parts used in the image forming apparatus and creates a cost penalty. Moreover, there may be a variety of requirements on the parts, for example accuracy on a flatness especially.

Another cleaning mechanism using a gap roller which selects materials of the cleaning mechanism to satisfy the requirement of maintaining an appropriate space between a photoreceptor drum and various kinds of members is proposed. Namely, a gap-roller-cleaning member is provided by selecting the surface material of a photoreceptor, a surface material of a roller and a material of toner so as to satisfy the relation (A) γG>γD, γT concerning a surface free energy γD of the surface of the photoreceptor, a surface free energy γG of the surface of the roller and a surface free energy γT of the toner, or the cleaning mechanism for the roller abutting part of the photoreceptor drum is provided by selecting them so as to satisfy the relation (B) γD>γT>γG. As a result, it is possible to effectively prevent toner or the like from remaining on a roller and a surface of a photoreceptor and to prevent foreign matter from adhering to the roller and the surface of the photoreceptor. However, a precise control is needed to achieve this configuration.

In another cleaning mechanism, a cleaning blade is oscillated to clean chips generated by scattering by a gap roller, it is necessary to introducing an oscillating cam to oscillate the cleaning blade. The cleaning mechanism becomes complicated and bears a cost penalty.

### SUMMARY OF THE INVENTION

This patent specification describes a novel image forming apparatus which includes an image carrier configured to form a latent image, a transfer roller configured to transfer a latent image, a gap controlling member configured to keep a predetermined distance between the image carrier and the transfer roller and a cleaning member configured to clean a surface of the image carrier, arranged to touch a contacting area on the surface of the image carrier with the gap controlling member and formed of a porous fibrous material in at least a contacting area of the cleaning member contacting with the image carrier.

This patent specification further describes a novel image forming apparatus which includes a cleaning mechanism configured to clean the image forming apparatus and includes a cleaning blade arranged at an effective area for the image forming and configured to contact with the surface of the image carrier in a longitudinal direction of the image carrier and a seal mechanism arranged between the cleaning blade and the cleaning member to prevent toner from dropping off.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an image forming apparatus according to an exemplary embodiment of the present invention;

FIG. 2 illustrates a side view of the image forming apparatus of FIG. 1;

FIG. 3 illustrates an oblique perspective view of a photosensitive drum to show a positional relationship between the photosensitive drum and a cleaning unit;

FIG. 4 illustrates a relevant part of the cleaning unit in a longitude direction of FIG. 3; and

FIG. 5 illustrates an oblique perspective view of another example of the cleaning unit attaching to a blanket.

### DETAILED DESCRIPTION OF THE PREFERRED EMBODIMENTS

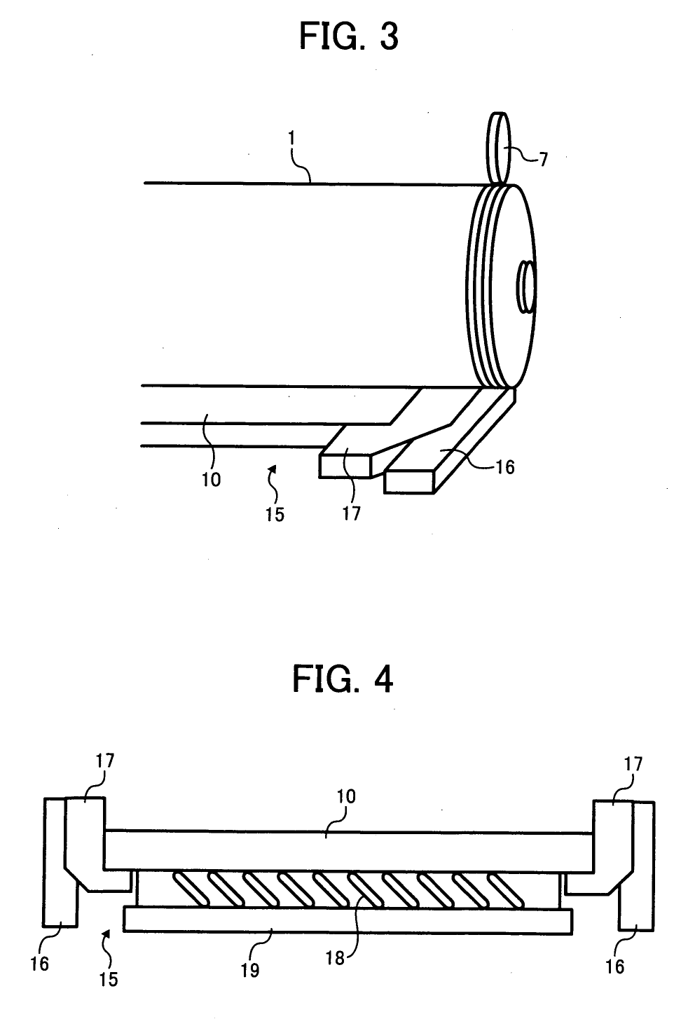

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIG. 3, an image forming apparatus according to an exemplary embodiment of the present invention is described.

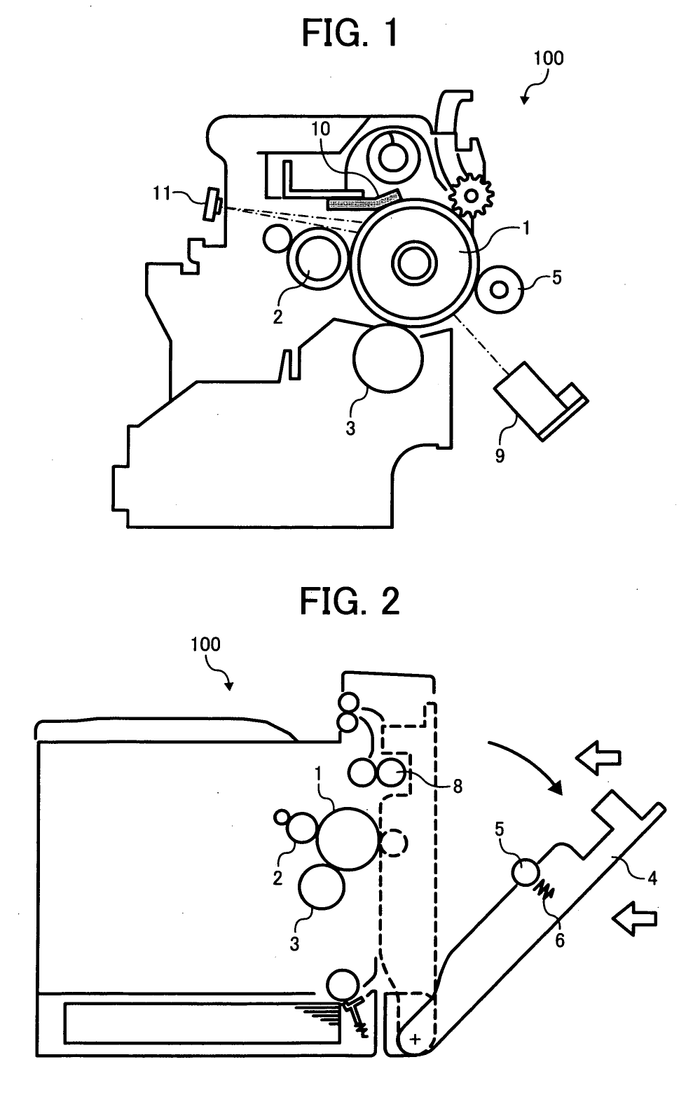

FIG. 1 and FIG. 2 illustrate a laser printer (printer 100) as one example of an image forming apparatus according to an exemplary embodiment. As shown in FIG. 1, the printer 100 includes a photosensitive drum 1, a charging roller 2, a development roller 3 and a transfer roller 5. The photosensitive drum 1 serves as an image carrier and is driven to rotate in a counterclockwise direction in FIG. 1. The charging roller 2 charges a surface of the photosensitive drum 1 uniformly. A laser beam is exposed and is scanned onto the surface of the photosensitive drum 1 by an optical writing unit (not shown) in accordance with image data so as to form a latent image on the surface of the photosensitive drum 1.

The latent image is developed to form a toner image on the surface of the photosensitive drum 1. A paper which is a recording medium is fed from a paper cassette (not shown) to the transfer roller 5 which is included in a transfer unit arranged at a right-side door 4. The toner image is transferred onto the paper by the transfer roller 5. The right-side door 4 is configured to be openable and closable and is attached to a main body of the printer 100. The transfer roller 5 is held with the right side door 4 and is pushed to the photosensitive drum 1 by a spring 6 when the right-side door 4 is closed.

Gap rollers 7 are arranged at both ends of a shaft of the transfer roller 5 as shown in FIG. 3. The gap rollers 7 are formed with a molding press method. In FIGS. 1 and 2, a direction of the shaft is perpendicular to a paper surface. The gap between the photosensitive drum I and the transfer roller 5 can be kept constant by the gap rollers 7. After completion of the transferring process, the toner image is fixed to the paper by a fixing apparatus 8. The paper is output to an output tray. A photosensor 9 is arranged at a position between the development roller 3 and the transfer roller 5 as shown in FIG. 1.

The photosensor 9 includes emitting and receiving elements and is configured to work as a color-image-density detector and a charging-voltage-correction device. A residual toner which is not transferred and exists on the photosensitive drum 1 is removed from a surface of the photosensitive drum 1 by a cleaning blade 10 of a cleaning unit 15. Further, the residual charge on the photosensitive drum 1 is removed by a neutralization lamp 11 which works as a neutralizing apparatus.

FIG. 3 illustrates the positional relationship between the photosensitive drum 1 and the cleaning unit 15 which cleans the photosensitive drum 1 when the photosensitive drum 1 and the cleaning unit 15 are released and placed upside down. The cleaning blade 10 is used to remove residual toner on an effective region of the photosensitive drum 1 for image forming. The cleaning blade 10 is formed of a rubber material so as to have good durability. A sub-cleaning member 16 is arranged at a circumference portion of the photosensitive drum I and the gap roller 7 so as to clean a mark on the photosensitive drum 1 made by the gap roller 7 while contacting with the gap roller 7. Moreover the gap roller 7 is arranged at a position outside the effective region of the photosensitive drum 1 for the image forming.

The cleaning blade 10 contacts with the surface of the photosensitive drum 1 in a longitude direction with a bend while the photosensitive drum 1 is being rotated. A portion of the residual toner removed by the cleaning blade 10 is conveyed to an outer side of the photosensitive drum 1 along a longitudinal direction of the photosensitive drum 1. Then, the residual toner conveyed is dropped off from an edge of the cleaning blade 10. To prevent the residual toner from dropping off, a seal blade 17 is arranged to contact with the photosensitive drum 1 at a position between the edge of the cleaning blade 10 and the sidewall of the sub-cleaning member 16.

FIG. 4 illustrates a relevant part of the cleaning unit 15 in a longitudinal direction as viewed from the top of FIG. 3. The photosensitive drum 1 is arranged in the same longitude direction. The seal blade 17 is closely contacted with the cleaning blade 10 and the sub-cleaning member 16. The seal blade 17 works as a wall so as to prevent the toner which is conveyed from dropping out. The seal blade 17 is made of, for example, a foamed polyurethane which has a good blocking characteristics.

The sub-cleaning member 16 is formed of a textile material which is suitable for tangling the toner having metal materials. The textile material has a porous surface called a felt and a nonwoven fabric. Aluminum particles are efficiently wiped off from the surface of the photosensitive drum 1 and are held by the textile material.

Thus, the sub-cleaning member 16 needs to be formed of the porous fibrous material in at least a contacting area with the photosensitive drum 1. If felt is used, it is possible to avoid further wearing of the surface of the photosensitive drum 1 which may be ruined due to the contact with the gap roller 7 because the felt has a low coefficient of friction. Moreover, felt can efficiently capture the grinded particles.

In FIG. 4, a waste-toner-salvage screw 18 is arranged at a further outside region of the cleaning blade 10 to restore the residual toner which is wiped by the cleaning blade 10. The waste-toner-salvage screw 18 has a slit and is rotated. The toner is conveyed in accordance with the rotation of the waste-toner-salvage screw 18 and is fed to the development unit for a recycling use. An entrance seal 19 is arranged at further outside region of the waste-toner-salvage screw 18 to seal the opposite side of the waste-toner-salvage screw 18. Edges of the entrance seal 19 are configured to touch the photosensitive drum 1.

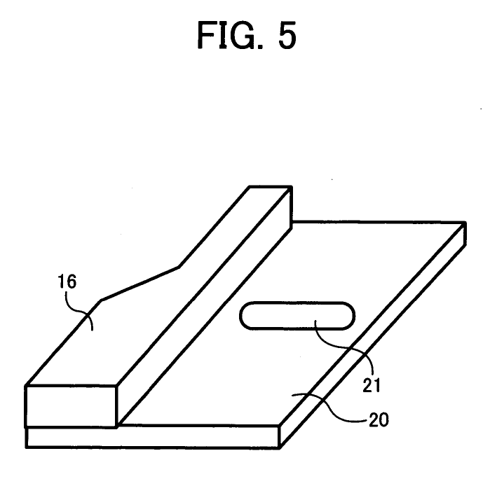

FIG. 5 illustrates another example of the sub-cleaning member 16 attaching to a blanket 20. The blanket 20 is formed of a metal plate and includes an elongate hole 21 in a middle of the blanket 20 to engage with a frame of main body of the printer 1 by a screw (not shown). The position of the sub-cleaning member 16 can be adjusted by adjusting a position of the elongate hole 21.

Numerous additional modifications and variations are possible in light of the above teachings. It is therefore to be understood that within the scope of the appended claims, the disclosure of this patent specification may be practiced otherwise than as specifically described herein.

1. An image forming apparatus comprising:
an image carrier configured to form a toner image;
a transfer roller configured to transfer the toner image to a recording medium;
a gap controlling member configured to keep a predetermined distance between the image carrier and the transfer roller; and
a cleaning member configured to clean a surface of the image carrier, said cleaning member being arranged to touch a contacting area on the surface of the image carrier with the gap controlling member and formed of a porous fibrous material in at least a contacting area of the cleaning member contacting with the image carrier.

2. The image forming apparatus of claim 1, further comprising:
a cleaning mechanism configured to clean the image forming apparatus and includes
a cleaning blade arranged at an effective area for image forming and configured to contact with the surface of the image carrier in a longitudinal direction of the image carrier, and
a seal mechanism arranged between the cleaning blade and the cleaning member to prevent toner from dropping off.

3. The image forming apparatus of claim 1, further comprising:
a blanket member configure to attach to the cleaning member,
wherein the blanket member includes an elongate hole to engage with a frame of a main body of the image forming apparatus.

4. An image forming apparatus comprising: image carrier means for forming a toner image;
transfer means for transferring the toner image to a recording medium;
gap controlling means for keeping a predetermined distance between the image carrier and the transfer roller; and
cleaning means for cleaning a surface of the image carrier, arranged to touch a contacting area on the surface of the image carrier means with the gap controlling means and formed of a porous fibrous material in at least a contacting area of the cleaning means contacting with the image carrier means.
